(19) United States
(12) Patent Application Publication
(10) Pub. No.: US 2023/0273647 A1
(43) Pub. Date: Aug. 31, 2023

(54) Power supply interface terminal capable of reducing wear

(71) Applicant: Dongguan Duanhua Electronic Technology Co., Ltd., Dongguan (CN)

(72) Inventor: Baohua Jin, Dongguan (CN)

(21) Appl. No.: 18/143,521

(22) Filed: May 4, 2023

(30) Foreign Application Priority Data
Nov. 16, 2022 (CN) 202223042627.2

(51) Int. Cl. G06F 1/16

(52) U.S. Cl. CPC G06F 1/1656

(57) ABSTRACT

Disclosed is a power supply interface terminal capable of reducing wear. The power supply interface terminal comprises a plug-in section, a positioning section and a wiring section. The plug-in section, the positioning section and the wiring section are sequentially connected from front to back. The plug-in section is provided with a plurality of contact springs. Rear ends of the contact springs are connected with the positioning section. A plug-in space is formed among the contact springs.

### TECHNICAL FIELD

The present disclosure relates to a power supply interface terminal, in particular to a power supply interface terminal capable of reducing wear.

### BACKGROUND

The power supply interface, also called a power supply connector, is mainly used in a power supply connecting wire of a computer. NVIDIA Company of the United States took the lead in introducing 12VHPWR power supply connectors which are used for supplying power for graphics cards of computers. The plug-in section of the 12VHPWR power supply connector is provided with two opposite contact plates. An inner surface of the contact plate is provided with a plurality of convex bumps. The convex bumps are in contact with PIN needles on the graphics card through the convex bumps, thus forming electric connection (referring to a terminal, a connector and electronic equipment disclosed in a Chinese patent with the application number of CN115241673A).

According to market feedback, the 12VHPWR power supply connector is often too high in temperature, even resulting in sintering and burning phenomena. The NVIDIA company puts forward the reason that the temperature is too high caused by excessive resistance due to bending of the connecting wire, and the structure of the terminal is also a factor.

Specifically, as shown in FIG. 1, for the terminal 500 of the present convex bump type structure, the two contact plates 510 are connected with the upper and lower supporting plates 520. The positions of the convex bumps 511 are relatively fixed. Although metal has certain ductility, the actual movable range of the convex bump 511 is extremely limited. When the PIN needles 400 are inserted, the convex bumps 511 and the PIN needles 400 are basically in rigid contact. With the increase of times of inserting and pulling, the PIN needles 400 and the convex bumps 511 are worn, resulting in decrease of contact area between the PIN needle and the convex bump and increase of resistance, thus causing the problem of too high temperature.

In addition, when the PIN needles 400 and the convex bumps 511 are severely worn, the PIN needle 400 and the convex bump 511 are possibly too small in joint force and poor in contact.

### SUMMARY

Through a technical scheme of the present disclosure, in order to solve the above problems, the present disclosure provides a power supply interface terminal capable of reducing wear. The terminal includes a plug-in section, a positioning section and a wiring section. The plug-in section, the positioning section and the wiring section are sequentially connected from front to back. The plug-in section is provided with a plurality of contact springs. Rear ends of the contact springs are connected with the positioning section. A plug-in space is formed among the contact springs. The contact springs can be elastically deformed along a direction away from the plug-in space.

Further, the contact springs are arranged in a 360° circumferential array.

Further, the number of the contact springs is four. Two contact springs are separated from each other along a left-right direction, and the other two contact springs are separated from each other along an upper-lower direction.

Further, the plug-in section is further provided with a receiving ring. Front ends of the contact springs are connected with the receiving ring.

Further, the positioning section is provided with a support frame, two positioning springs and two guide plates. The rear ends of the contact springs are connected with the support frame. The two positioning springs respectively protrude outward from left and right sides of the support frame. The two guide plates are located at a rear end of the support frame and separated from each other along the left-right direction.

Further, the wiring section is provided with a receiving plate and a wiring element. A front end of the receiving plate is connected with the positioning section. The wiring element is connected with the receiving plate.

Further, the wiring element includes wire clamps. The wire clamp is located at a lower end of the receiving plate. The number of the wire clamps is two. The two wire clamps are separated from each other along a front-rear direction.

Further, the wiring element is a wiring board. The wiring board is connected with a rear end of the receiving plate. The wiring section is further provided with a connecting plate. The connecting plate is connected with a side edge of the receiving plate.

After the technical scheme is adopted, the present disclosure has the following beneficial effects. For the power supply interface terminal, a contact structure of the contact springs is adopted, so that the degree of wear between the power supply interface terminal and PIN needles can be reduced, and the problems of excessive temperature and sintering are avoided. Meanwhile, force required for inserting and pulling can be enhanced, and the contact stability can be improved.

### BRIEF DESCRIPTION OF THE DRAWINGS

FIG. 1 is a partial horizontal sectional view when a terminal is plugged in the prior art;

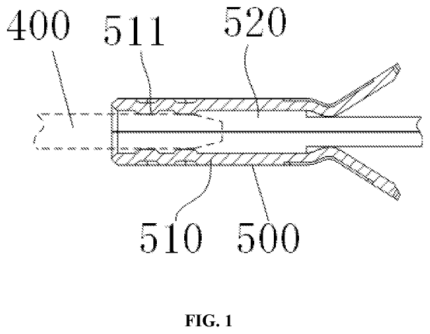

FIG. 2 is a schematic diagram of the terminal in a first embodiment of the present disclosure;

FIG. 3 is a schematic diagram of a power supply interface in the first embodiment of the present disclosure;

FIG. 4 is a partial horizontal sectional view when the terminal is plugged in the first embodiment of the present disclosure; and

FIG. 5 is a schematic diagram of the terminal in a second embodiment of the present disclosure.

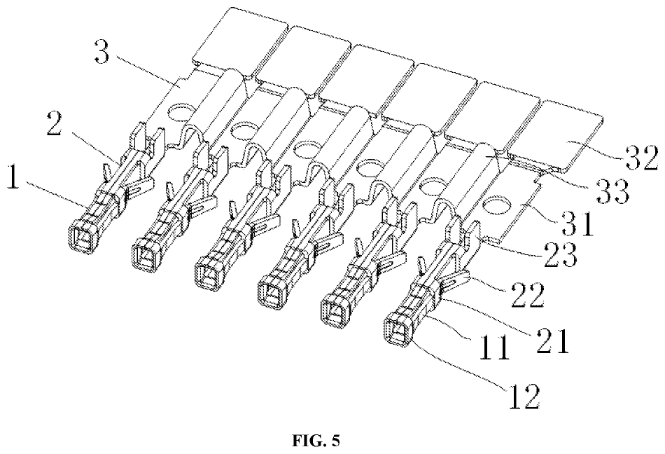

### DETAILED DESCRIPTION OF THE EMBODIMENTS

The description of the present disclosure is further described in conjunction with the following embodiments.

### Embodiment I

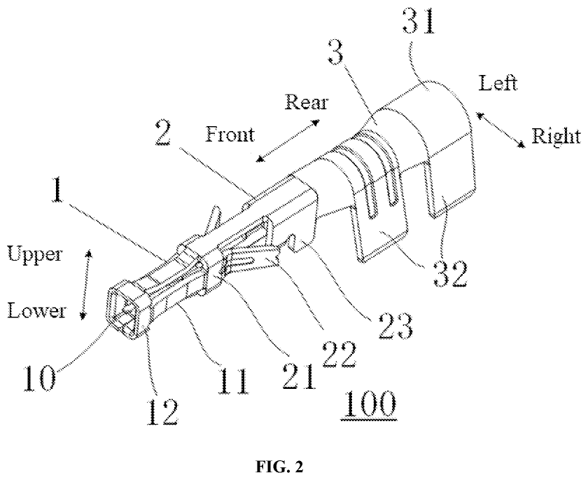

The present disclosure provides a power supply interface terminal capable of reducing wear. As shown in FIG. 2, the terminal 100 includes a plug-in section 1, a positioning section 2 and a wiring section 3. The plug-in section 1, the positioning section 2 and the wiring section 3 are sequentially connected from front to back. The plug-in section 1 is provided with a plurality of contact springs 11. Rear ends of the contact springs 11 are connected with the positioning section 2. A plug-in space 10 is formed among the contact springs 11. The contact springs 11 can be elastically deformed along a direction away from the plug-in space 10.

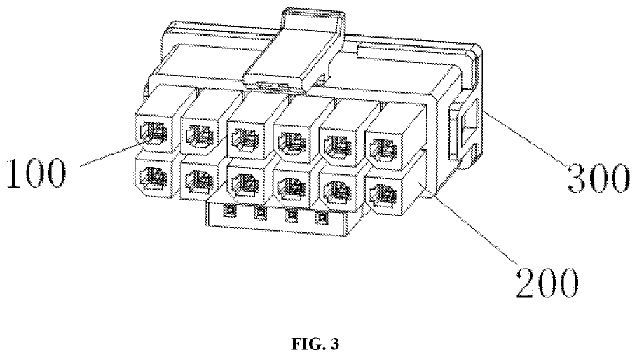

As shown in FIG. 3, the power supply interface includes the terminals 100 arranged in two rows, a main body 200 and a rear cover 300. When the terminals 100 are installed, the terminals 100 are inserted into the main body 200 from back to front. The positioning section 2 of the terminal 100 is engaged with the a clamping position of the main body 200, and then the rear cover 300 is installed at a rear end of the main body 200. A connecting wire is connected with wiring section 3 of the terminal, so that the terminal 100 is fixed and electrically connected.

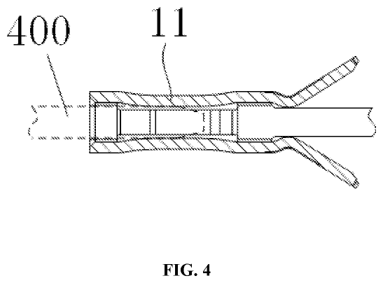

As shown in FIG. 4, when in use, a power supply interface on the connecting wire is plugged into a socket of a video card. A plurality of PIN needle 400 of the video card are respectively inserted into the plug-in spaces 10 of the plug-in sections 1 of the terminals 100. Two opposite contact springs 11 of the plug-in section 1 are respectively in contact with two side surfaces of the PIN needle 400 and elastically deformed in a direction away from the plug-in space 10 as the PIN needle 400 is inserted. Through the contact between the contact spring 11 and the PIN needle 400, electrical connection can be formed, so that power transmission can be realized. Under the action of elastic force, force required for inserting and pulling can be enhanced, and the contact stability can be improved. Because the two contact springs 11 are elastically deformed in a direction away from the plug-in space 10, the contact between the contact spring 11 and the PIN needle 400 is flexible contact, so that the degree of wear is reduced.

Specifically, referring to FIG. 2, the contact springs 11 are arranged in a 360° circumferential array. After the PIN needle 400 is inserted, the contact springs 11 are uniformly distributed around the PIN needle 400, so that the contact positions and the contact force are uniformly arranged, and the contact stability is improved.

More specifically, in the embodiment, the number of the contact springs 11 is four, two contact springs 11 are separated from each other along a left-right direction, and the other two contact springs 11 are separated from each other along an upper-lower direction. The four contact springs 11 are in contact with upper, lower, left and right surfaces of the PIN needle 400, respectively.

Specifically, the plug-in section 1 is further provided with a receiving ring 12, and front ends of the contact springs 11 are connected with the receiving ring 12. Front and rear ends of the contact spring 11 are positioned by the receiving ring 12 and the positioning section 2, respectively. A middle part of the contact spring 11 can be elastically deformed in a direction away from the plug-in space 10.

Specifically, the positioning section 2 is provided with a support frame 21, two positioning springs 22 and two guide plates 23. The rear ends of the contact springs 11 are connected with the support frame 21. The two positioning springs 22 respectively protrude outward from left and right sides of the support frame 21. The two guide plates 23 are located at a rear end of the support frame 21 and separated from each other along the left-right direction. When the terminal 100 is installed, the two guide plates 23 are matched with the guide bars of the main body 200 to guide the insertion process of the terminal 100. After the terminal 100 is installed in place, the two positioning springs 22 are respectively engaged with two clamping positions of the main body 200, so that the terminal 100 is fixed.

Specifically, the wiring section 3 is provided with a receiving plate 31 and a wiring element 32. A front end of the receiving plate 31 is connected with the positioning section 2. The wiring element 32 is connected with the receiving plate 31. The wiring element 32 is used for making contact with the connecting wire and forming electric connection.

More specifically, in the embodiment, the wiring element 32 includes wire clamps. The wire clamp is located at a lower end of the receiving plate 31. The number of the wire clamps is two. The two wire clamps are separated from each other along a front-rear direction. During wiring, cores, in contact with the connecting wire, of the two wire clamps are in contact with each other to be fixed.

### Embodiment II

In the embodiment, a row of terminals 100 of the power supply interface are integrally formed. When the terminals 100 are installed, the entire row of terminals 100 are inserted into the main body 200 at the same time. The structure is a continuous terminal structure and also known as an internal terminal structure. A row of terminals 100 can be installed at the same time, so that the efficiency is high.

Wherein, the wiring element 32 of the wiring section 3 is a wiring board. The wiring board is connected with a rear end of the receiving plate 31. The wiring section 3 is further provided with a connecting plate 33. The connecting plate 33 is connected with a side edge of the receiving plate 31. During wiring, the wiring board is welded with a wire core of the connecting wire to be fixed. The connecting plate 33 is connected with the left side or the right side of the receiving plate 31 so as to connect a row of terminals 100 as a whole.

What is claimed is:

1. A power supply interface terminal capable of reducing wear, comprising a plug-in section, a positioning section and a wiring section, wherein the plug-in section, the positioning section and the wiring section are sequentially connected from front to back, the plug-in section is provided with a plurality of contact springs, rear ends of the contact springs are connected with the positioning section, a plug-in space is formed among the contact springs, and the contact springs can be elastically deformed along a direction away from the plug-in space.

2. The power supply interface terminal capable of reducing wear according to claim 1, wherein the contact springs are arranged in a 360° circumferential array.

3. The power supply interface terminal capable of reducing wear according to claim 2, wherein the number of the contact springs is four, two contact springs are separated from each other along a left-right direction, and the other two contact springs are separated from each other along an upper-lower direction.

4. The power supply interface terminal capable of reducing wear according to claim 1, wherein the plug-in section is further provided with a receiving ring, and front ends of the contact springs are connected with the receiving ring.

5. The power supply interface terminal capable of reducing wear according to claim 1, wherein the positioning section is provided with a support frame, two positioning springs and two guide plates, the rear ends of the contact springs are connected with the support frame, the two positioning springs respectively protrude outward from left and right sides of the support frame, and the two guide plates are located at a rear end of the support frame and separated from each other along the left-right direction.

6. The power supply interface terminal capable of reducing wear according to claim 1, wherein the wiring section is provided with a receiving plate and a wiring element, a front end of the receiving plate is connected with the positioning section, and the wiring element is connected with the receiving plate.

7. The power supply interface terminal capable of reducing wear according to claim 6, wherein the wiring element comprises wire clamps, the wire clamp is located at a lower end of the receiving plate, and the number of the wire clamps is two, and the two wire clamps are separated from each other along a front-rear direction.

8. The power supply interface terminal capable of reducing wear according to claim 6, wherein the wiring element is a wiring board, the wiring board is connected with a rear end of the receiving plate, the wiring section is further provided with a connecting plate, and the connecting plate is connected with a side edge of the receiving plate.
